(19) United States
(12) Patent Application Publication
(10) Pub. No.: US 2008/0222114 A1
(43) Pub. Date: Sep. 11, 2008

(54) EFFICIENT DIRECTED ACYCLIC GRAPH REPRESENTATION

(75) Inventor: Zvi Schreiber, Jerusalem (IL)

Correspondence Address: SIMON KAHN - PYI Tech, Ltd.;c/o LANDONIP, INC, 1700 DIAGONAL ROAD, SUITE 450, ALEXANDRIA, VA, 22314-2866, US

(73) Assignee: GHOST INC., Tortola (VG)

(21) Appl. No.: 12/045,037

(22) Filed: Mar. 10, 2008

Related U.S. Application Data
(60) Provisional application No. 60/893,968, filed on Mar. 9, 2007.

(51) Int. Cl. G06F 7/06; G06F 17/30

(52) U.S. Cl. 707/3; 707/104.1; 707/E17.014

(57) ABSTRACT

An efficient representation of a changing directed acyclic graph (DAG) in a computer system. A representation of all the paths in the DAG are stored in memory and kept synchronized with the representation of the DAG which may change over time. This allows some important queries to be performed very quickly such as finding all the descendants of a node.

### CROSS-REFERENCE TO RELATED APPLICATIONS

This application claims priority from U.S. Provisional Patent Application Ser. No. 60,893,968 filed Mar. 9, 2007, entitled “Virtual Hosted Operating System” the entire contents of which is incorporated herein by reference.

### BACKGROUND OF THE INVENTION

The invention is related to a method of computer software and modeling and more specifically to a computer implemented method of persisting directed acylic graphs.

A common construct in computer science is the directed acyclic graph (DAG). This construct has a set of nodes, one of which is a root, and directed edges between some pairs of nodes such that every node is reachable from the root and such that there are no cycles of edges. By way of a non-limiting example of where a GAD arises, the folders in a typical file system without shortcuts form a tree, but after adding shortcuts between folders it typically becomes a DAG, since there is often more than one path from the root to a folder.

A particularly important use of DAGs is the one created by the classes in an object-oriented modeling or programming language, for example UML static class diagrams and/or C++, once an inheritance relationship, including multiple-inheritance, is added between the classes, provided that a top level class such as ‘object’ is provided in the language. An example of this type of DAG is shown in FIG. 1, which will be described further hereinto below.

A known challenge for most storage mechanisms, such as relational databases which represent data in tabular format, is that they are not able to directly represent DAGs. It is possible to represent DAGs using one table to list all the nodes and another table to list all the edges, where each edge is represented as a pair of nodes. In a non-limiting example, a DAG is represented using two columns in an edge table, with one column representing a direction from the node and another column representing to the node. However this representation is very inefficient for answering certain standard queries such as: “find all the descendants of a node n”. Such a query cannot be expresses as a single database query using this representation and cannot be achieved in reasonable time.

Most prior art algorithms focus on finding, or at least approximating, a transitive closure of the DAG, i.e. a list of all pairs of nodes which are connected through one or more edges. In particular, many algorithms focus on finding the entire transitive closure, as required. However, if a DAG is changing reasonably often, then computing a transitive closure each time the DAG changes is extremely inefficient.

One particular prior art reference, “Maintaining Transitive Closure of Graphs in SQL”, by Ghozhu Dong et al., published 1999 in the International Journal of Information Technology, the entire contents of which is incorporated herein by reference, and in particular section 2 of the reference, Transitive Closure of Acyclic Graphs, of the reference, goes further and presents a way of persisting in memory a representation of the transitive closure. Whenever the DAG is updated, the transitive closure is also updated, thereby saving the need to compute it from scratch after every change. The transitive closure maybe used to rapidly answer queries like “is node F descendent from node A” or “find all descendents of node X”. However, there is no efficient algorithm for updating the transitive closure when an edge is removed from the DAG, thus making this solution inappropriate for very large DAGs, or for use with DAGs exhibiting edges which are deleted frequently.

### SUMMARY OF THE INVENTION

Accordingly, it is a principal object of the present invention to provide a computer implemented method of representing DAGs in memory. Instead of persisting just the nodes and edges of the DAG's, or just the nodes, edges and transitive closure of the DAG's, the present invention persists a full enumeration of all paths in the DAG and updates it whenever the DAG updates. Storing a representation of all paths requires more memory than storing a representation of the transitive closure and significantly more memory than just storing the nodes and edges, however advantageously storing the representation of all paths makes certain important queries significantly faster. Additionally, the algorithms for updating the path table when an edge is deleted are more efficient than the algorithms for updating a transitive closure table of the prior art.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a sample DAG comprising classes in an object oriented programming language, with multiple inheritance relationships between them, in accordance with the prior art;

FIG. 2 illustrates a high level block diagram of a computing platform in accordance with a principle of the current invention

FIG. 3 illustrates a UML static class diagram Metamodel for representing a DAG, including nodes and edges, together with paths, according to a principle of the invention;

FIG. 4 illustrates an example of a DAG and paths, according to a principle of the invention, as stored in the memory of the computing platform of FIG. 2;

FIGS. 5A-5E illustrates examples of the DAG of FIG. 4 and the paths thereof represented in a relational database according to a principle of the invention;

FIG. 6A illustrates a high level flow chart of a computer implemented method, according to a principle of the invention, operable in association with the computing platform of FIG. 2, to efficiently update the data structures when an edge is removed from a DAG; and

FIG. 6B illustrates a high level flow chart of a computer implemented method, according to a principle of the invention, operable in association with the computing platform of FIG. 2, to efficiently update the data structures when an edge is added to a DAG.

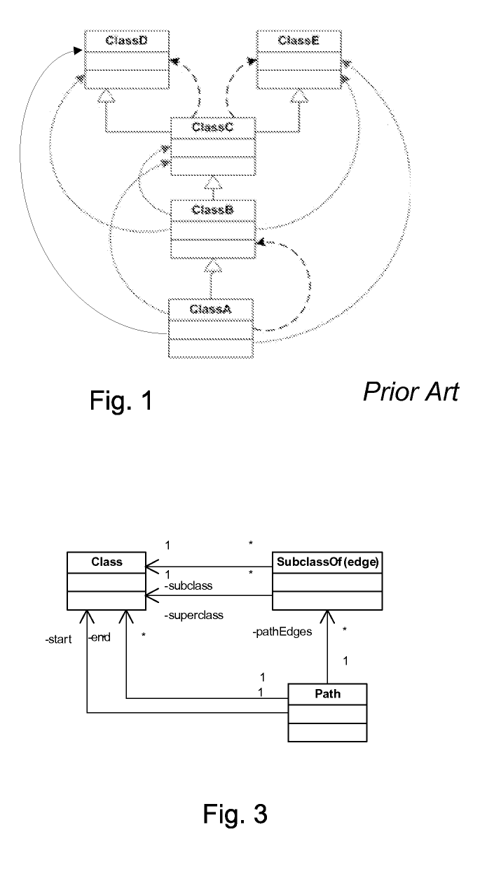

### DETAILED DESCRIPTION OF THE PREFERRED EMBODIMENTS

The present embodiments enable a computer implemented method of representing DAGs in memory, comprising persisting a full path table in memory, and updating the path table whenever the DAG updates.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

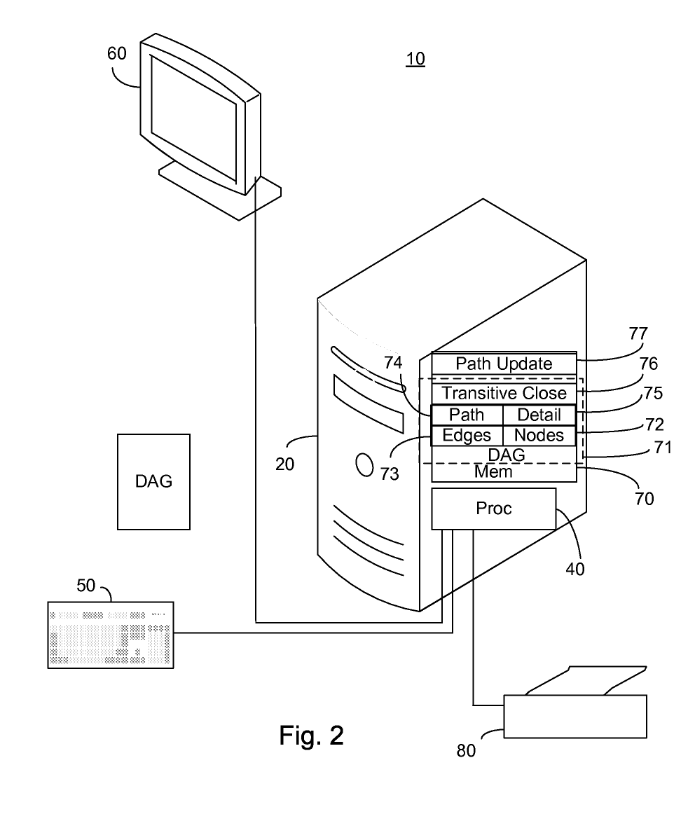

FIG. 2 illustrates a high level block diagram of a computing platform 10 in accordance with a principle of the current invention comprising: a computing device 20 comprising a processor 40 and a memory 70; a user input device 50; a monitor 60; and an output device 80, such as a printer. Memory 70 comprises a relational database representation of a DAG 71, including a nodes table 72; an edges table 73; a path table 74; a path detail table 75; an optional transitive closure table 76; and path updating functionality 77. Path updating functionality 77 represents computer readable instructions, enabling processor 40 to update nodes table 72, edges table 73, path table 74, path detail table 75 and optional transitive closure table 76 whenever DAG 71 changes. Monitor 60 is coupled to an output of processor 40 and computing device 20 is connected to user input device 50. Processor 40 is further in communication with memory 70, user input 50 and output device 80.

User input device 50 is illustrated as a keyboard, however this is not meant to be limiting in any way. The use of any or all of a pointing device, a voice input, or a touch screen is equally applicable and is specifically included. Memory 70 is illustrated as being internal to computing device 20, however this is not meant to be limiting in any way. All or parts of memory 70 may be provided external to computing device 20, such as a network server, the Internet, or a removable computer readable media, without exceeding the scope of the invention.

Computing platform 10 has been described as having a monitor and a user input device 50 associated therewith, however this is not meant to be limiting in any way. In one embodiment computing platform 10 is constituted of a server, comprising a web server or other application programming interface for processing requests received from a connected network.

Memory 70 of computing device 20 is further operative to store the computer implemented method according to the principle of the invention in computer readable format for execution by computing device 20.

The invention addresses a situation where DAG 71 is represented in memory 70 as a list of nodes and list of edges, each edge being an ordered pair of nodes, which changes from time to time. In one non-limiting embodiment DAG 71 represents folders in a file system and in another non-limiting embodiment DAG 71 represents classes in a dynamically changing object-oriented data model.

According to an embodiment of the invention, there is additionally stored in memory 70 a data representation of all paths in the DAG, which is stored within nodes table 72; edges table 73; path table 74; path detail table 75; and optional transitive closure table 76.

FIG. 3 illustrates a UML static class diagram Metamodel for representing a DAG, including nodes and edges, together with paths, according to a principle of the invention. The object-oriented Metamodel of FIG. 3 may also be converted into a persistence scheme using Object Relational Mapping. One embodiment of a resultant relational database schema, including sample data, is shown in FIGS. 5A-5E.

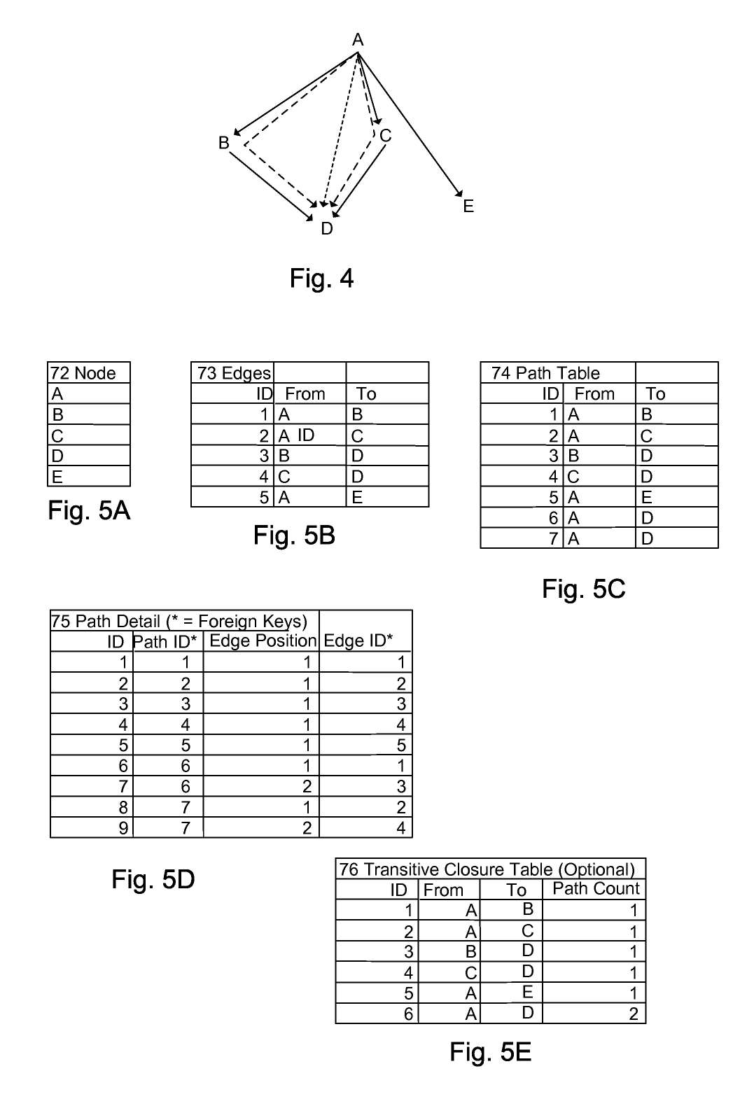

In particular, referring to FIG. 4, which illustrates an example of a DAG and paths, according to a principle of the invention, as stored in the memory of computing platform 10 of FIG. 2, the diagram shows nodes A, B, C, D, and E and edges AB, AC, BA, CD and AE. Nodes A, B, C, D and E in one embodiment represent classes; and edges AB, AC, BA, CD and AE in one embodiment represent superclass—subclass relationships. The transitive closure is the edges plus the dashed line AD. The paths are the edges plus the two paths, each of which is a sequence of edges, AC BD; AC CD shown with a broader dash.

In particular, FIG. 5A illustrates an embodiment of node table 72; FIG. 5B illustrates an embodiment of Edges table 73; FIG. 5C illustrates an embodiment of path table 74; FIG. 5D illustrates an embodiment of path detail table 75; and FIG. 5E illustrates an embodiment of optional transitive closure table 76.

In one embodiment, the method according to a principle of the invention captures every single path from any node to any node in DAG 71. Every path is an ordered list of edges. For efficiency, the method according to the principle of the invention also directly points at both the starting point and the end point of the path even those may be calculated from the first and last edges in the path. In one embodiment, (not shown), the “empty path” from each edge to itself is also stored in path table 74, without any corresponding path details in path detail table 75.

### Queries

With the existence of path table 74 certain important queries can be performed much more directly and efficiently than would otherwise be possible, even using a single query of a database query language SQL.

1. Is B descendant from A?

A is tested to check if it is an ancestor of B directly by simply querying to see if there is one or more paths found in Path Table 74 whose start is A and end is B.

In another embodiment, transitive closure table 76 which is always precisely equal to path table 74 with the exception that all duplications of paths which have the same start and finish have been removed, is also implemented. Each pair in transitive closure table 76 preferably includes a count of how many paths correspond to each transitive closure, so that it the path is preferably removed when the count reaches 0. Thus, when a path is deleted the corresponding transitive closure is deleted by using the count, without the need to query to see if there are other paths with the same start and finish.

It will be appreciated that a query “find all descendants of A” or “find all ancestors of A” can also be achieved with a direct query of the path table, although duplicate results should then be removed, or by querying the transitive closure table.

### Update Algorithms

### 2. Removing an Edge

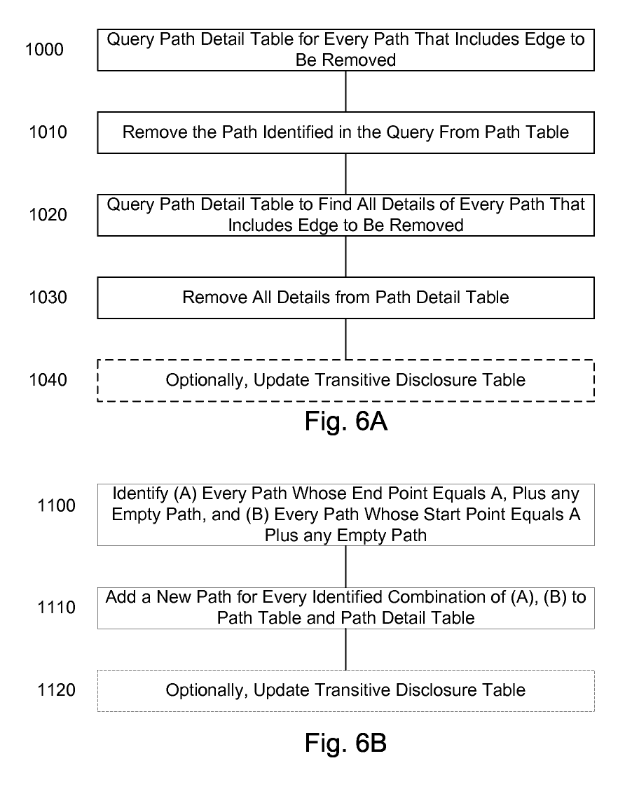

FIG. 6A illustrates a high level flow chart of a computer implemented method, according to a principle of the invention, operable in association with computing platform 10 of FIG. 2, to remove an edge from a DAG. In stage 1000, path detail table 75 is queried for every path that includes the edge to be removed. In stage 1010, the paths identified in the query of stage 1000 are removed from path table 74. In stage 1020, path detail table 75 is queried to find all the details of every path that includes the edge to be removed, as described above in relation to stage 1000, from the DAG. In stage 1030, the details identified in stage 1020 are removed from path detail table 75. In this way removing an edge requires three simple database queries: a) finding the paths of stage 1000; b) removing the path from the path table of stage 1010; c) finding and removing the details of the paths of stages 1020, 1030. Optionally, in stage 1040, transitive closure table 76 is updated. The below pseudo code implements removing an edge from a DAG, the corresponding path table 74 and corresponding path detail table 75 as described in FIG. 6A.

```
//1.Initiate a transaction
  Transaction.beginTransaction( );
  //Obtain a global write lock on TC, InheritancePath, PathEdges
tables.
  PathTables.obtainLock( )
  //define the class-superclass edge
  currentEdge = new Edge(sourceGhClass, targetGhClass);
  //retreave P1: paths containing the currentEdge from the PathEdges
Table
  paths = ″SELECT PATHS FROM INHERITANCE_PATHS IH,
PATH_EDGES PE WHERE HI.ID IN (SELECT
  PE.INHERITANCE_PATH_ID FROM PATH_EDGES WHERE
PE.START =” + currentEdge.getId( ) + “ & PE.END
  =” currentEdge.getId( ))”;
  //delete all paths, and using cascade, delete all related edges in
the EDGES_TABLE .
  dbTables.remove(paths);
  //search the TC table, if records with count > 1, then decrement the
count by 1,
  //else, if the count ==1, then delete the raw.newPath = new
Path( );
  for i=0; i<paths.length {
    tcRecord = “SELECT * FROM TC WHERE
    TC.ID = “ + paths[i].getId( );
    if tcRecord.getCount( ) > 1 {
      tcRecord.incrementCount( );
  }else {
    db.deleteTCRecord(tcRecord);
  }
}
//commit will release the write lock.
Transaction.commit( );
//free resources.
Transaction.close( );
}
```

### 3. Adding an Edge

FIG. 6B illustrates a high level flow chart of a computer implemented method, according to a principle of the invention, operable in association with computing platform 10 of FIG. 2, to add an edge to a DAG. In stage 1100, identify (A) every path C1 . . . Cn whose end point Cn equals A, plus the empty path with no edges, and (B) every path D1 . . . Dn whose start D1=A plus the empty path with no edges.

In stage 1110, add a new path with nodes C1 . . . Cn D1 . . . Dn for each combination of a path from set (A) followed by a path of set (B) of the path sets A and B identified in stage 1110 to path table 74 and add the details to path detail table 75 (i.e. the edges C1-C2, C2-C3, . . . Cn-D1, D1-D2 . . . ). The set of combinations of paths from A and paths from B is sometimes known in mathematics as the cross product. Optionally, in stage 1120, transitive closure table 76 is updated by adding for each new path C1 . . . Cn D1 . . . Dn, a transitive closure C1-Dn if it doesn't exist, or optionally incrementing its count if it already exists. The below pseudo code implements adding an edge to a DAG and the corresponding path table 74 and path detail table 75.

```
//1.Initiate a transaction
  Transaction.beginTransaction( );
  //Obtain a global write lock on TC, InheritancePath, PathEdges
tables.
  PathTables.obtainLock( )
  //define the class-superclass edge
  currentEdge = new Edge(sourceGhClass, targetGhClass);
  //retreave P1: paths ending with SourceGhClass
  p1 = ″SELECT * FROM INHERITANCE_PATHS IH
WHERE IH.START =″ + sourceGhClass.getId( );
  p2 = ″SELECT * FROM INHERITANCE_PATHS IH WHERE
IH.END =″ + target.getId( );
  //construct the new paths
  newPath = new Path( );
  newPaths = new Path[];
  for i=0; i<p1.length {
    for j=0; j<p2.length {
      newPaths.add(newPath(p1[i] + currentEdge + p2[j]));
    }
  }
  //save the new paths to the DB, which include.
  //insert the new paths to the InheritancePath table and the
PathEdges table.
  //Constructing the SQL insert statement
  inheritancePathInsertSQl = ″INSERT INTO INHERITANCE_PATH,
  VALUES (″;
  pathEdgesInsertSQL = ″INSERT INTO PATH_EDGES VALUES (″;
  //loop thought the newPaths, and construct the sql insert statement
  for i=0; i<newPaths.length {
      //insert the newPath paths records in the inheritance_path table.
      inheritancePathInsertSQl += newPaths[i].getStart( ) + ″,″ +
  newPath[i].getEnd + ″), (″;
      for j=0; j<newPaths[i].getEdgesSize( )
      pathEdgesInsertSQL += newPaths[i].getid( ) + ″, ″ +
  newPaths[j].getEdge(j).getStart( ) + ″, ″
      newPaths[j].getEdge(j).getEnd + ′), (″;
  }
  inheritancePathInsertSQL += “)”
  pathEdgesInsertSQL += “)”;
  execute(inheritancePathInsertSQL);
  execute(pathEdgesInsertSQl);
  //update the TC table
  //Look on the TC table, if the raw is available, then increment the
TC.count by one, //else,
  add new raw, setting the Tc.count to 1.
  for i=0; i<newPaths.length {
      tcRecord = findTCRecord(newPaths[i]);
      if (tcRecord != null) {
        tcRecord.incrementCounter( );
        tcRecord.save( );
      }
      Else {
        tcRecord = new TCRecord(newPath[i]);
        tcRecord.save( );
    }
  }
  //commit will release the write lock.
  Transaction.commit( );
  //free resources.
  Transaction.close( );
  }
```

Those skilled in the art of relational database and/or programming will be able to code the data structures, database schemas and specific transactions and queries reasonably easily using the above guidelines.

### SUMMARY

By storing both DAG 71 as well as the path table 74, and path detail table 75, a simple and relatively quick computer implemented algorithm for checking ancestors and descendants using the path table, and/or using a transitive closure table derived from it by eliminating duplicates, is provided. Additionally, FIG. 6A and FIG. 6B describe algorithms for updating the path table when edges are added or removed which are more efficient than prior art algorithms for updating transitive closure tables when a path table is not present.

The price for this efficiency is the extra storage required for the path table and also the time taken by transactions for adding and removing edges.

### EXAMPLE

By way of an example, which corresponds to the diagrams of FIGS. 3-5, consider a DAG with nodes comprising of Classes A, B, C, D, E with superclass-subclass edges AB, AC, BD, CD, AE.

The paths are the following seven sequences of edges: AB; AC; BD; CD; AE; AB BD; AC CD

The transitive closure is the start and finish nodes of the path table with duplications removed in this case:

AB (count 1); AC (count 1); BD (count 1); CD (count 1); AE (count 1); AD (count 2).

To remove the edge BD, as described in relation to FIG. 6A, remove every path containing BD from path table 74 which are the paths BD and AB BD. Further remove the details of these paths from path detail table 75, i.e. every path detail which points at that path using that Path ID foreign key. For path BD, the Path ID is the detail containing the edge BD and for AB BD is the two details AB and BD. In transitive closure table 76 we decrement the count of AD by one since there is now one less path from A to D, and we remove BD which now has a count of zero.

To add edge EC, as described in relation to FIG. 6B, i.e. a user tells us that C is a subclass of E, take all the paths ending at E including empty path (AE, empty path) and all those starting at C (CD, empty path) and “cross product” them so that the set of paths to add to path table 74 with corresponding details are the 2×2=4 new paths:

Empty path−EC−Empty path=EC

AE EC−Empty path=AE EC;

Empty path−EC CD=EC CD;

### AE EC CD

It will be appreciated that adding or removing a node does not require any updates to the edge table 73, path table 74, path detail table 75 or optional transitive closure table 76.

The corresponding counts must be updated in transitive closure table 76 for every start and finish of a path, e.g. increment the relationships EC, AC, ED and AC in the transitive closure or create if non-existent.

Thus, the present embodiments enable a computer implemented method of representing DAGs in memory, comprising persisting a full path table in memory, and updating the path table whenever the DAG updates.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

I claim:

1. A computer implemented method of persisting directed acylic graphs, comprising:
storing all paths of the directed acyclic graph; and
storing all details of the stored paths.

2. A computer implemented method according to claim 1, further comprising:
querying, in the event of a removal of an edge, said stored paths to identify paths including said removed edge;
removing, responsive to said query of said stored paths, said identified paths including said removed edge from said stored paths;
querying, in the event of a removal of an edge, said stored path details to identify paths including said removed edge; and
removing, responsive to said query of said stored path details, said identified paths including said removed edge, from said stored details.

3. A computer implemented method according to claim 2, further comprising in the event of a removal of an edge, updating a transitive closure table.

4. A computer implemented method according to claim 2, further comprising:
identifying, in the event of an addition an edge, every path whose end point is the added edge and every path whose start point is the added edge;
computing all the combinations of said every path whose end point is the added edge and said every path whose start point is the added edge
storing a paths for each said combination; and
storing the details of said identified paths.

5. A computer implemented method according to claim 4, further comprising in the event of an addition of an edge, updating a transitive closure table.

6. A computer implemented method according to claim 1, further comprising:
identifying, in the event of an addition an edge, every path whose end point is the added edge and every path whose start point is the added edge;
determining all the combinations of said identified paths whose end point is the added edge and said identified paths whose start point is the added edge;
storing each of said determined combinations as a path; and
storing the details of said determined combination paths.

7. A computer implemented method according to claim 6, further comprising in the event of an addition of an edge, updating a transitive closure table.

8. A computer implemented method according to claim 1, wherein at least some nodes of the directed acyclic graph nodes are folders in a file system.

9. A computer implemented method according to claim 1, wherein at least some nodes in the DAG are classes in an object oriented class inheritance heirarchy.

10. A computer-readable medium containing instructions for controlling a data processing system to perform a computer implemented method of persisting directed acylic graphs, the computer implemented method comprising:
storing all paths of the directed acylic graph; and
storing all details of the stored paths.

11. A computer-readable medium according to claim 10, wherein the method further comprises:
querying, in the event of a removal of an edge, said stored paths to identify paths including said removed edge;
removing, responsive to said query of said stored paths, said identified paths including said removed edge from said stored paths;
querying, in the event of a removal of an edge, said stored path details to identify paths including said removed edge; and
removing, responsive to said query of said stored path details, said identified paths including said removed edge, from said stored details.

12. A computer-readable medium according to claim 11, wherein the method further comprises in the event of a removal of an edge, updating a transitive closure table.

13. A computer-readable medium according to claim 11, wherein the method further comprises:
identifying, in the event of an addition an edge, every path whose end point is the added edge and every path whose start point is the added edge;
determining all the combinations of said identified paths whose end point is the added edge and said identified paths whose start point is the added edge;
storing each of said determined combinations as a path; and
storing the details of said determined combination paths.

14. A computer-readable medium according to claim 13, wherein the method further comprises in the event of an addition of an edge, updating a transitive closure table.

15. A computer-readable medium according to claim 10, wherein the method further comprises:
identifying, in the event of an addition an edge, every path whose end point is the added edge and every path whose start point is the added edge;
determining all the combinations of said identified paths whose end point is the added edge and said identified paths whose start point is the added edge;
storing each of said determined combinations as a path; and
storing the details of said determined combination paths.

16. A computer-readable medium according to claim 15, wherein the method further comprises in the event of an addition of an edge, updating a transitive closure table.

17. A computer-readable medium according to claim 10, wherein at least some nodes of the directed acyclic graph nodes are folders in a file system.

18. A computer-readable medium according to claim 10, wherein at least some nodes in the DAG are classes in an object oriented class inheritance heirarchy.

19. A computing platform operative to persist directed acylic graphs, the computing platform comprising a computer, a memory and a query functionality, the computer being operative to:
store all paths of the directed acylic graph in a path table in the memory; and
store all details of the stored paths in a path detail table in the memory.

20. A computing platform according to claim 19, wherein the computer is further operative to;
query, in the event of a removal of an edge, and via the query functionality, said stored paths in said path table to identify paths including said removed edge;
remove, responsive to said query of said stored paths, said identified paths including said removed edge from said stored paths of said path table;
query, in the event of a removal of an edge, and via the query functionality, said stored path details of said path detail table to identify paths including said removed edge; and
remove, responsive to said query of said stored path details, said identified paths including said removed edge, from said stored details of said path detail table.

21. A computing platform according to claim 20, wherein the computer is further operative in the event of a removal of an edge to update a transitive closure table in the memory.

22. A computing platform according to claim 20, wherein the computer is further operative to:
identify, in the event of an addition an edge, every path whose end point is the added edge and every path whose start point is the added edge;
determine all the combinations of said identified paths whose end point is the added edge and said identified paths whose start point is the added edge;
store each of said determined combinations as a path; and
store the details of said determined combination paths.

23. A computing platform according to claim 22, wherein the computer is further operative in the event of an addition of an edge to updating a transitive closure table in the memory.

24. A computing platform according to claim 19, wherein the computer is further operative to:
identify, in the event of an addition an edge, every path whose end point is the added edge and every path whose start point is the added edge;
determine all the combinations of said identified paths whose end point is the added edge and said identified paths whose start point is the added edge;
store each of said determined combinations as a path; and
store the details of said determined combination paths.

25. A computing platform according to claim 23, wherein the computer is further operative in the event of an addition of an edge to updating a transitive closure table in the memory.

26. A computing platform according to claim 19, wherein at least some nodes of the directed acyclic graph nodes are folders in a file system.

27. A computer-readable medium according to claim 19, wherein at least some nodes in the DAG are classes in an object oriented class inheritance heirarchy.

28. A database for persisting a directed acylic graph comprising:
a path table constituted of all paths of the directed acyclic graph; and
a path detail table constituted of details of all paths in said path table.

29. A database according to claim 28, further comprising:
a transitive closure table substantially equal to said path table with all duplications of paths which have the same start and finish removed.
